(19) United States
(12) Patent Application Publication
(10) Pub. No.: US 2025/0182648 A1
(43) Pub. Date: Jun. 5, 2025

(54) BRAILLE BLOCK WITH QR CODE DISPLAYED FOR GUIDING THE VISUALLY IMPAIRED AND INFORMATION GUIDANCE SYSTEM USING SAME

(71) Applicant: EYESHARENET INC., Jeju-si, Jeju-do (KR)

(72) Inventor: Gun Woo NAM, Jeju-si, Jeju-do (KR)

(21) Appl. No.: 18/839,644

(22) PCT Filed: Dec. 12, 2023
(86) PCT No.: PCT/KR2023/020393

§ 371 Date: Aug. 19, 2024

(30) Foreign Application Priority Data
Oct. 6, 2023 (KR) 10-2023-0133620

(51) Int. Cl. G09B 21/00; A61H 3/06; E01C 15/00; G01C 21/36

(52) U.S. Cl. CPC G09B 21/005; A61H 3/061; A61H 3/066; G01C 21/3652; A61H 2201/5064; A61H 2201/5092; E01C 15/00

(57) ABSTRACT

Proposed are a braille block with a QR code displayed for guiding the visually impaired and an information guidance system using the same, which more accurately provides the next movement information to the visually impaired on the basis of the movement route of the visually impaired and the entry direction into the current braille block analyzed through recognition of the QR code contained in the braille block, especially which analyzes and provides the information necessary to make corrections to the location of the braille block or corrections related to the QR code information contained in the braille block by analyzing whether the visually impaired actually move to or enter the guided braille block in the correct direction, and additionally which selects and provides customized information suitable for the corresponding visually impaired person among information contained in the QR code or content provided through the center server.

### TECHNICAL FIELD

The present disclosure relates to a braille block with a QR code displayed for guiding the visually impaired and an information guidance system using the same and, more specifically, to a braille block with a QR code displayed for guiding the visually impaired and an information guidance system for the visually impaired using the same, which more accurately provides the next movement information to the visually impaired on the basis of the movement route of the visually impaired and the entry direction into the current braille block analyzed through recognition of the QR code contained in the braille block, especially which analyzes and provides the information necessary to make corrections to the location of the braille block or corrections related to the QR code information contained in the braille block by analyzing whether the visually impaired actually move to or enter the guided braille block in the correct direction in comparison with the guided movement information, and additionally which selects and provides customized information suitable for the corresponding visually impaired person among information contained in the QR code or content provided through the center server on the basis of information analyzed and provided for a specific visually impaired person.

### BACKGROUND ART

Braille blocks are being constructed on sidewalks on both sides of the road to guide the walking of the visually impaired, and there are two main types of braille blocks: linear blocks that guide the entry direction of sidewalks, the crossing direction of the crosswalk, and the entry direction of the entrance, and spotted blocks that are installed at the beginning and end of crosswalks, underpasses, overpasses, and stairs to guide people to stop in the right place.

Meanwhile, most smartphone users have installed QR code-related apps (which are also recognized by the camera's default program) to utilize the fact that QR codes are being applied in many areas of life, such as connecting to a corresponding internet service when capturing QR codes attached to buildings or streetlights with smartphones.

Since braille blocks for the disabled installed and used on sidewalks provide only limited information, there may be many difficulties for the visually impaired to travel or reach a desired destination using only information from these braille blocks.

### Patent Literature

Korea Patent No. 10-2444954, “Sidewalk blocks equipped with QR codes” (Registered on Sep. 21, 2022)

What is disclosed in the preceding <patent literature> relates to a sidewalk block with a QR code implemented, which allows pedestrians to scan and receive various information with a smartphone on the spot by implementing the QR code on the sidewalk block, and which allows pedestrians to receive various information as desired at their location through the smartphone they carry by scanning the QR code engraved in the surface of the sidewalk block through CNC processing.

That is, the preceding <patent literature> implements just the sidewalk block itself into the QR code to provide necessary information, and is completely unrelated to implementing a QR code on a braille block for the visually impaired to provide various information such as accurate route guidance to the visually impaired.

### DISCLOSURE OF THE INVENTION

### Technical Problem

The present disclosure is devised to solve the problems above, and
the objective of the present disclosure is to provide a braille block with a QR code displayed for guiding the visually impaired, which identifies the direction where the visually impaired enter the corresponding braille block by forming the QR code to be formed on the braille block on a part of the braille block for the visually impaired, in particular, in a sectional area rather than in the center when the rectangular braille block is divided into rectangular sections of equal size.

Another objective of the present disclosure is to provide an information guidance system for the visually impaired using a braille block with a QR code displayed for guiding the visually impaired, which more accurately provides the next movement information to the visually impaired on the basis of the movement route of the visually impaired and the entry direction into the current braille block analyzed through the recognition of the QR code contained in the braille block.

Another objective of the present disclosure is to provide an information guidance system for the visually impaired using the braille block with the QR code displayed for guiding the visually impaired, which analyzes and provides the information necessary to make corrections to the location of the braille block or corrections related to the QR code information contained in the braille block by analyzing whether the visually impaired actually move to or enter the guided braille block in the correct direction in comparison with the guided movement information.

Another objective of the present disclosure is to provide an information guidance system for the visually impaired using the braille block with the QR code displayed for guiding the visually impaired, which selects and provides customized information suitable for the corresponding visually impaired person among information contained in the QR code or content provided through the center server on the basis of information analyzed and provided for a specific visually impaired person.

### Technical Solution

In order to achieve the objectives above, the present disclosure may be implemented by exemplary embodiments having the following configuration.

According to an exemplary embodiment of the present disclosure, a braille block with a QR code displayed for guiding the visually impaired according to the present disclosure includes a QR code display unit where the QR code containing various information is displayed on the surface of the braille block, wherein the QR code display unit is formed on a part of the braille block.

According to another exemplary embodiment of the present disclosure, the QR code display unit in the present disclosure may be characterized as being formed in a sectional area rather than in a center or in a center area of one side surface when a rectangular braille block is divided into rectangular sections of equal size.

According to another exemplary embodiment of the present disclosure, the QR code display unit in the present disclosure may be characterized as being formed by printing the QR code on a separate member to be attached to the braille block.

According to another exemplary embodiment of the present disclosure, an information guidance system for the visually impaired using a braille block with a QR code displayed for guiding the visually impaired according to the present disclosure may be characterized as including a braille block, a blind guidance device including a camera that the visually impaired carry and that recognizes the QR code displayed on the surface of the braille block, and a center server that provides content linked to various information contained in the QR code.

According to another exemplary embodiment of the present disclosure, the blind guidance device in the present disclosure may further include an information processing unit that analyzes information contained in the QR code recognized through the camera and provides various information to the visually impaired, wherein the information processing unit includes a route guidance unit that analyzes information contained in the QR code and provides guidance on a route to a destination to the visually impaired.

According to another exemplary embodiment of the present disclosure, the route guidance unit may be characterized as including an entry direction analysis module that identifies an entry direction of the visually impaired on the basis of where the QR code recognized by the camera is located in the braille block, a movement route analysis module that identifies a movement route of the visually impaired on the basis of an order of the QR code recognized by the camera, and a movement information guidance module that provides guidance on a next movement information to the visually impaired on the basis of the movement route analyzed by the movement route analysis module and the entry direction to a current braille block analyzed by the entry direction analysis module.

According to another exemplary embodiment of the present disclosure, the movement information guidance module may be characterized as precisely calculating a route by correcting a difference between a GPS location value of the QR code information recognized by the camera and a GPS location value received by the blind guidance device when calculating the route that provides guidance on the next movement information to the destination to the visually impaired.

According to another exemplary embodiment of the present disclosure, the center server may include a braille block feedback unit that analyzes and provides the information necessary to make corrections related to the braille block on the basis of feedback information of the route guidance unit, wherein the braille block feedback unit includes a braille block location feedback module that analyzes and provides the information necessary to make corrections to a location of the braille block by analyzing whether the visually impaired actually move to a guided braille block or enter in a correct direction through the entry direction analysis module or the movement route analysis module in comparison with a movement information provided through the movement information guidance module, and a QR code information feedback module that analyzes and provides the information necessary to make corrections related to a QR code information contained in the braille block by analyzing the movement route the visually impaired actually move along through the movement route analysis module in comparison with the movement information provided through the movement information guide module.

According to another exemplary embodiment of the present disclosure, the information processing unit in the present disclosure may be characterized as additionally including a customized information provision unit that provides customized information for a corresponding visually impaired person on the basis of information related to the visually impaired, information contained in the QR code, or content provided through the center server.

According to another exemplary embodiment of the present disclosure, the customized information provision unit in the present disclosure may be characterized as including an input information analysis module that analyzes information provided by the visually impaired, such as a taste or an interest, a user analysis module that analyzes information of interest to the corresponding visually impaired person on the basis of information of a destination frequently visited by the visually impaired through the route guidance unit, and a customized information provision module that selects and provides customized information suitable for the corresponding visually impaired person among information contained in the QR code or content provided through the center server on the basis of information analyzed and provided through the input information analysis module and the user analysis module.

### Advantageous Effects

The present disclosure may achieve the following effects by the exemplary embodiments as explained before the configuration, the combination, and the use relationship to be described below.

The present disclosure may have an effect of accurately identifying the direction where the visually impaired enter the corresponding braille block by forming the QR code to be formed in the braille block on a part of the braille block for the visually impaired, especially in a sectional area rather than in the center when the rectangular braille block is divided into rectangular sections of equal size.

The present disclosure may have an effect of more accurately providing the next movement information to the visually impaired on the basis of the movement route of the visually impaired and the entry direction into the current braille block analyzed through the recognition of the QR code contained in the braille block.

The present disclosure may have an effect of analyzing and providing the information necessary to make corrections to the location of the braille block or corrections related to QR code information contained in the braille block by analyzing whether the visually impaired actually move to or enter the guided braille block in the correct direction in comparison with the guided movement information.

The present disclosure may have an effect of selecting and providing customized information suitable for the corresponding visually impaired person among information contained in the QR code or content provided through the center server on the basis of information analyzed and provided for a specific visually impaired person.

### DESCRIPTION OF DRAWINGS

FIG. 1 is a reference view showing an example of a braille block with a QR code displayed for guiding the visually impaired according to the present disclosure.

FIG. 2 is a view showing a main configuration of an information guidance system for the visually impaired according to the present disclosure.

FIG. 3 is a view showing a detailed configuration of a blind guidance device.

FIG. 4 is a view showing a detailed configuration of a center server.

*Description of Reference Numerals

| | |
|---|---|
| 10: braille block | 110: QR code display unit |
| 30: blind guidance device | 310: camera |
| 320: information processing unit | 321: route guidance unit |
| 211: entry direction analysis module | 3212: movement route analysis module |
| 3213: movement information guidance module | 322: customized information provision unit |
| 3221: input information analysis module | 3222: user analysis module |
| 3223: customized information provision module | 50: center server |
| 510: braille block feedback unit | 511: braille block location feedback module |
| 512: QR code information feedback module | |

### BEST MODE

Hereinafter, preferred exemplary embodiments of a braille block with a QR code displayed for guiding the visually impaired and an information guidance system for the visually impaired using the same according to the present disclosure will be described in detail with reference to the accompanying drawings. It should be noted that the same components in the drawings are represented by the same codes wherever possible. Unless otherwise defined, all terms of the present specification are the same as the general meaning of the terms understood by those skilled in the art to which the present disclosure pertains, and when there is a conflict with the meaning of the terms used in this specification, the definition used herein shall govern. Throughout the specification, when a part “includes” a component, it means that other components may be further included, rather than excluding other components unless otherwise stated, and also, terms such as “ . . . unit”, “ . . . module”, and the like described in the specification refer to a unit that processes at least one function or operation, which may be implemented by hardware, software or a combination of hardware and software.

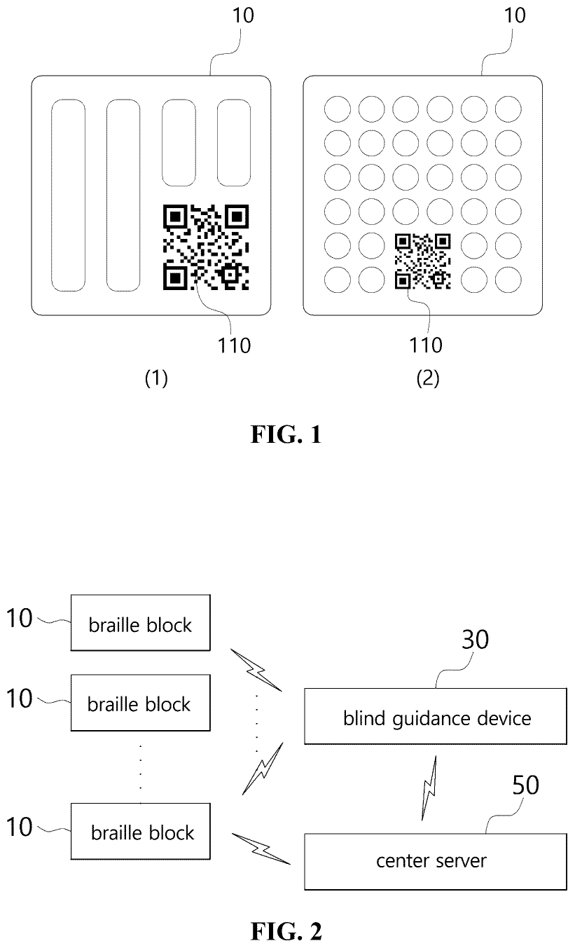

Referring to FIG. 1, a braille block 10 with a QR code displayed for guiding the visually impaired according to an exemplary embodiment of the present disclosure may include a QR code display unit 110 where a QR code containing various information is displayed on the surface, and the QR code display unit 110 may be characterized as being formed in a part of the braille block 10, in particular, in a sectional area rather than in the center when the rectangular braille block 10 is divided into rectangular sections of equal size.

The braille block 10 may be a block constructed to guide the visually impaired walking on a sidewalk where people move, and may be a concept of including linear blocks that guide the direction of the walkway, the crossing direction of the crosswalk, and the entry direction into an entrance, and spotted blocks that are installed at the beginning and end of crosswalks, underpasses, overpasses, and stairs to guide people to stop at the right place.

The QR code display unit 110 may refer to a part where a QR code containing various information is displayed on the surface of the braille block, wherein the QR code contains various information such as the current location, surrounding buildings, and surrounding related content and may be displayed in various forms, such as being displayed in an intaglio or embossed shape on the surface of the braille block, being attached in the form of a separate film, or being formed by printing the QR code on a separate member to be attached to the braille block.

In particular, the QR code display unit 110 in the present disclosure may be characterized as being formed on a part of the braille block 10, especially, in a sectional area rather than in the center when the rectangular braille block 10 is divided into rectangular sections of equal size. That is, when the QR code display unit 110 is formed on the entire braille block 10 or in the very center of the braille block 10, it is impossible to identify which direction of the braille block 10 the visually impaired approach the corresponding braille block 10 when approaching the braille block 10 and recognizing the QR code of the QR code display unit 110 formed in the braille block 10, but, contrary to this, when the QR code display unit 110 is formed in one section of the four divided sections of the rectangular braille block 10 (see FIG. 1(1)), or in the lower center section (being formed in the center of one side surface of braille block) of the nine divided sections (see FIG. 1(2)) as in an exemplary embodiment shown in FIG. 1, the approach direction may be clearly identified depending on (that is, as an example in FIG. 1(1) when the visually impaired recognize the QR code while approaching from left to right, the QR code display unit 110 is located on the upper right side on the screen where the camera 310 recognizes the braille block 10, and when recognizing the QR code while approaching from right to left, the QR code display unit 110 is located on the lower left side on the screen where the camera 310 recognizes the braille block 10) where the QR code display unit 110 is located on the screen where the camera 310 to be described later recognizes the braille block 10 when recognizing the QR code of the QR code display unit 110 formed on the braille block 10 in the direction of approaching the braille block 10.

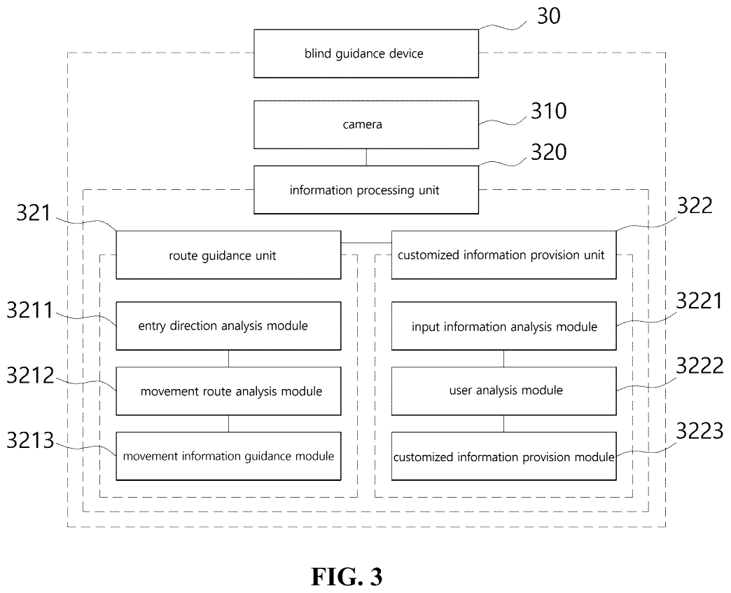

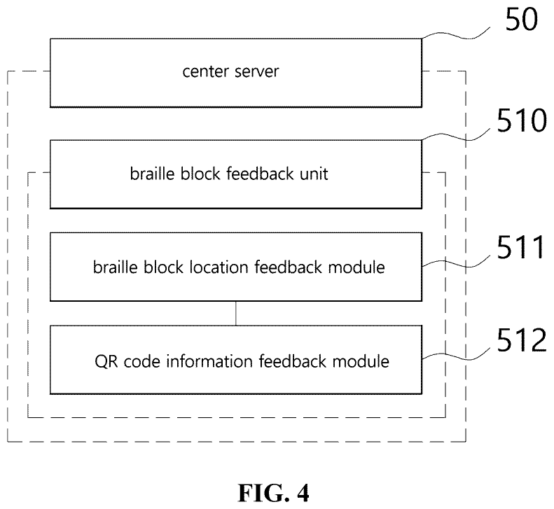

Meanwhile, referring to FIGS. 2 to 4, an information guidance system for the visually impaired using a braille block with a QR code displayed for guiding the visually impaired according to another exemplary embodiment of the present disclosure may be characterized as including a braille block 10, a blind guidance device 30 including a camera 310 that the visually impaired carry and that recognizes the QR code displayed on the surface of the braille block 10, and a center server 50 that provides content linked to various information contained in the QR code.

The blind guidance device 30 may be configured to be carried by a blind person, recognize the QR code displayed on the surface of the braille block 10, and provide various analysis information accordingly, and while a smart cane (possible to implement cameras, GPS, and analysis functions) carried by the visually impaired may be typically utilized, a smartphone carried by the visually impaired may be utilized or various types of smart devices may be utilized as long as being capable of taking a forward image, receiving a separate GPS location, or having an information analysis function. More specifically, the blind guidance device 30 may include a camera 310 and an information processing unit 320 that provides various information to the visually impaired by analyzing information contained in the QR code recognized through the camera 310.

The camera 310 may be configured to recognize the QR code displayed on the surface of the braille block 10, may perform a function of receiving the corresponding information by recognizing the approached braille block 10 and by photographing the same to recognize the QR code formed in the surface of braille block 10 while being formed in front of the blind guidance device 30 or the like, and may be utilized in various forms, such as a form in which a function to recognize the QR code and provide the information is implemented in a general CCD module.

The information processing unit 320 may be configured to analyze information contained in the QR code recognized through the camera 310 and to provide various information to the visually impaired, and to this end, more specifically, the information processing unit 320 may include a route guidance unit 321 that analyzes information contained in the QR code and provides guidance on a route to a destination to the visually impaired, and a customized information provision unit 322 that provides customized information for the corresponding visually impaired person on the basis of information related to the visually impaired, information contained in the QR code, or content provided through the center server 50.

The route guidance unit 321 may be configured to analyze information contained in the QR code and provide guidance on the route to the destination to the visually impaired, and to this end, more specifically, the route guidance unit 321 may include an entry direction analysis module 3211 that identifies the entry direction of the visually impaired on the basis of where the QR code (the QR code display unit 110) recognized by the camera 310 is located in the braille block 10, a movement route analysis module 3212 that identifies the movement route of the visually impaired on the basis of the order of the QR code (the QR code display unit 110) recognized by the camera 310, and a movement information guidance module 3213 that provides guidance on the next movement information to the visually impaired on the basis of the movement route analyzed by the movement route analysis module 3212 and the entry direction into the current braille block 10 analyzed by the entry direction analysis module 3211.

The entry direction analysis module 3211 may be configured to identify the entry direction of the visually impaired on the basis of where the QR code (the QR code display unit 110) recognized by the camera 310 is located in the braille block 10, and, as explained before, since the braille block 10 applied to the present disclosure allows the QR code display unit 110 formed on the surface to be formed in a sectional area rather than in the center when the rectangular braille block 10 is divided into rectangular sections of equal size, which part of the braille block 10 the QR code (the QR code display unit 110) recognized by the camera 310 of the blind guidance device 30 will be located may be different depending on which direction the visually impaired enter the corresponding braille block 10 such that the entry direction analysis module 3211 can identify the entry direction of which direction the visually impaired enters the braille block 10. In an example, as shown in FIG. 1(1), in the case where a QR code (the QR code display unit 110) is formed in one section of the four-divided sections of the rectangular braille block 10, the QR code display unit 110 may be located at the upper right on the screen where the camera 310 recognizes the braille block 10 when the visually impaired recognize the QR code while approaching the braille block 10 in a left-to-right direction, whereas the QR code display unit 110 is located at the lower left on the screen where the camera 310 recognizes the braille block 10 when the visually impaired recognize the QR code while approaching the braille block 10 from the right side to the left side of the braille block 10, so the entry direction analysis module 3211 may clearly identify the approach direction by identifying the entry direction of the visually impaired on the basis of which part of the braille block 10 the QR code (the QR code display unit 110) recognized by the camera 310 is located.

The movement route analysis module 3212 may be configured to identify the movement route of the visually impaired on the basis of the order of the QR codes (the QR code display unit 110) recognized by the camera 310, and the braille blocks 10 with the QR code display unit 110 formed on the surface may be located at every specific point on the walkway, and the visually impaired may recognize the braille block 10 with the QR code display unit 110 formed on the surface sequentially through the camera 310 while moving, such that the movement route analysis module 3212 can identify, analyze, and provide a movement route of which route the corresponding visually impaired person has moved so far on the basis of the order information of the QR codes (the QR code display unit 110) of the braille blocks 10 recognized by the camera 310 of the blind guidance device 30 the visually impaired carry.

The movement information guidance module 3213 may be configured to provide guidance on the next movement information to the visually impaired on the basis of the movement route analyzed by the movement route analysis module 3212 and the entry direction into the current braille block 10 analyzed by the entry direction analysis module 3211, and when a visually impaired person inputs information about the destination (including intermediate stopovers, etc.) to which he or she wishes to move into the information processing unit 320 of the blind guidance device 30, the information processing unit 320 may provide guidance on the route to the destination, and, in this case, after identifying in the movement information guidance module 3213 the movement information that the visually impaired move on the basis of the analysis information through the movement route analysis module 3212, and then additionally identifying the entry direction information of which direction the visually impaired person enter the specific braille block 10 at the current location on the basis of the analysis information through the entry direction analysis module 3211, with that information, the movement information guidance module 3213 may analyze and provide guidance on the next movement information to the destination on the basis of more accurate analysis information about the current location (at this time, the current location may be more accurately identified by correcting the difference between the GPS location value of the QR code information recognized by the camera 310 and the separate GPS location value received from the blind guidance device 30) of the visually impaired and about which direction the visually impaired person is facing. That is, in the case of the visually impaired, when the movement direction is slightly wrong at some point, the movement onward from that point may happen to be completely wrong, even when moving well up to that point, so providing movement information for the next movement to the visually impaired may be possible more accurately when which direction the body of the current visually impaired person is facing at the moment is accurately identified (that is, depending on which direction the visually impaired person's body is facing in the braille block in front of the crosswalk at an intersection, the intended crosswalk may be in front of the visually impaired or to the right). Therefore, the movement information guidance module 3213 may be able to provide accurate movement information for the next movement to the visually impaired more accurately since the movement information guidance module is especially based on information on the entry direction (the direction in which the visually impaired person's body is facing at the current location) into the braille block 10 which is analyzed by the entry direction analysis module 3211 in addition to the movement route information that the visually impaired person moved in the past and that is analyzed in the movement route analysis module 3212.

The customized information provision unit 322 may be configured to provide customized information for the visually impaired on the basis of information related to the visually impaired, information contained in the QR code, or content provided through the center server 50, and to this end, more specifically, the customized information provision unit 322 may include an input information analysis module 3221 that analyzes information provided by the visually impaired, such as tastes and interests, a user analysis module 3222 that analyzes information of interest to the visually impaired person on the basis of destination information frequently visited by the visually impaired through the route guidance unit 321, and a customized information provision module 3223 that selects and provides customized information suitable for the visually impaired among information included in the QR code or content provided through the center server 50 on the basis of information analyzed and provided through the input information analysis module 3221 and the user analysis module 3222.

The input information analysis module 3221 may be configured to analyze information provided by the visually impaired, such as tastes or interests, wherein the visually impaired input information in advance such as his/her interests in reading, music, history or the like through the blind guidance device in order to provide customized information suitable for the visually impaired, and the input information analysis module 3221 may analyze information, which is inputted in this way or collected through other routes, on tastes or interests of the visually impaired and may provide the same to the customized information provision module 3223 to be described later.

The user analysis module 3222 may be configured to analyze information of interest to the visually impaired on the basis of information on the destination frequently visited by the visually impaired through the route guidance unit 321, and the route guidance unit 321 may accumulate information on the destination (including intermediate stopovers) frequently visited by the corresponding visually impaired person when the visually impaired continuously receives guidance on a movement route through the blind guidance device 30 applied to the present disclosure, and using the accumulated destination information (including intermediate stopovers), the user analysis module 2222 may analyze which places or facilities the visually impaired mainly visit such as museums, libraries, trails, social welfare facilities, etc. and may provide information of interest to the corresponding visually impaired person.

The customized information provision module 3223 may be configured to select and provide customized information suitable for the corresponding visually impaired person among information contained in the QR code or content provided through the center server 50 on the basis of the information analyzed and provided through the input information analysis module 3221 and the user analysis module 3222. The information contained in the QR code or the content information provided through the center server 50 may include various types of information, but it may be unnecessary to provide all such information to the visually impaired passing through a specific point, and also providing unnecessary information to the visually impaired may cause fatigue. Therefore, it may be a more effective information provision to selectively provide only customized information that the corresponding visually impaired person is interested in among such information, and the customized information provision module 3223 may enable such a customized information provision. That is, for example, in the case of a specific visually impaired person when inputting through the input information analysis module 3221 that he/she enjoys drinking coffee and analyzing the interest as ‘coffee’, and additionally when analyzing through the user analysis module 3222 that coffee shops of a specific brand are frequently visited as the frequently visited coffee shop, the customized information provision module 3223 may select and provide only the relevant information when a nearby coffee shop of the corresponding specific brand is included among information provided from the QR code of the braille block 10 where the visually impaired person is currently located or the content information provided through the center server 50 in connection therewith.

The center server 50 may be configured to provide, analyze, and modify (feedback) content linked to various information contained in the QR code, and as examples of content linked to various information contained in the QR Code, the information contained in the corresponding QR code may correspond to the location information, relevant information about the history, chronology, facilities, events, etc. related to the corresponding location or building as information on buildings around the location, or major facility information at the corresponding location. The center server 50 may produce, provide, analyze, and modify (feedback) the corresponding content and, more specifically, the center server 50 may include a braille block feedback unit 510 that analyzes and provides the information necessary to make corrections related to the braille block on the basis of the feedback information of the route guidance unit.

More specifically, the braille block feedback unit 510 may include a braille block location feedback module 511 that analyzes and provides the information necessary to make corrections to the location of the braille block 10 by analyzing whether the visually impaired actually move to the guided braille block 10 or enter in the correct direction through the entry direction analysis module 3211 or the movement route analysis module 3212 in comparison with the movement information provided through the movement information guidance module 3213, and a QR code information feedback module 512 that analyzes and provides the information necessary to make corrections related to the QR code information contained in the braille block 10 by analyzing the movement route that the visually impaired actually move along through the movement route analysis module 3212 in comparison with the movement information provided through the movement information guidance module 3213.

The braille block location feedback module 511 may be configured to analyze and provide the information necessary to make corrections to the location of the braille block 10 by analyzing whether the visually impaired actually move to the guided braille block 10 or enter in the correct direction through the entry direction analysis module 3211 or the movement route analysis module 3212 in comparison with the movement information provided through the movement information guidance module 3213. That is, even when the visually impaired receive guidance on the movement route, there are frequent cases where they move differently from the intended route, the main reason of which is that the braille block meant to guide the walking of the visually impaired is installed in the wrong location or direction. However, there may be few cases where information on these incorrectly installed braille blocks can be confirmed and judged without the active reporting of the visually impaired. In the present disclosure, it may be possible through the braille block location feedback module 511 to collect information on locations where the visually impaired frequently moves in the wrong direction in comparison with information (through the movement information guidance module 3213) on the movement route the visually impaired is guided to and information (possible to collect through the movement route analysis module 3212) on how to actually move afterward, and especially feedback on the location of the braille block may be possible through such an analyzed information provision by analyzing the information necessary to make corrections to the installation location or installation direction for a specific braille block when merging and analyzing information (possible to collect through the entry direction analysis module 3211) on the entry direction of the visually impaired into a specific braille block 10 at the point of moving along the wrong route.

The QR code information feedback module 512 that analyzes and provides the information necessary to make corrections related to the QR code information contained in the braille block 10 by analyzing the movement route that the visually impaired actually move along through the movement route analysis module 3212 in comparison with the movement information provided through the movement information guidance module 3213. As explained above, feedback may be possible through the braille block location feedback module 511 when the main reason for the case where the visually impaired move differently even when the visually impaired are guided about the movement route is that the braille blocks for guiding the walking of the visually impaired are installed in an incorrect location or in an incorrect direction, but the present disclosure may guide the movement route of the visually impaired on the basis of information obtained through a specific braille block 10 containing the QR code, and at this time ultimately may provide a cause for the visually impaired to move along the wrong direction when the information itself provided through the QR code is wrong. Therefore, the QR code information feedback module 512 may analyze and provide the information necessary to make corrections to the QR code information itself. As an example, the QR code information feedback module 512 may analyze and provide the information necessary to make corrections related to the QR code information contained in the braille block 10 by analyzing the movement route the visually impaired actually move along through the movement route analysis module 3212 when in spite of the recent installation of a diagonal crosswalk at the intersection, the QR code of the braille block 10 at the corresponding intersection still contains the information that you need to cross the crosswalk from the front and then cross the crosswalk from the side in order to move diagonally and the visually impaired are frequently using the inconvenient route of using two crosswalks.

In the above, the applicant has described various exemplary embodiments of the present disclosure, but these exemplary embodiments are merely exemplary embodiments of the technical ideas of the present disclosure, and any change or modification examples that implement the technical idea of the present disclosure should be construed as falling within the scope of the present disclosure as long as the technical idea of the present disclosure is implemented.

1. A braille block with a QR code displayed for guiding the visually impaired, the braille block comprising: a QR code display unit where the QR code containing various information is displayed on a surface of the braille block, wherein the QR code display unit is formed on a part of the braille block.

2. The braille block of claim 1, wherein the QR code display unit is formed in a sectional area rather than in a center or in a center area of one side surface when a rectangular braille block is divided into rectangular sections of equal size.

3. The braille block of claim 1, wherein the QR code display unit is formed by printing the QR code on a separate member to be attached on the braille block.

4. An information guidance system for the visually impaired using a braille block with a QR code displayed for guiding the visually impaired, the system comprising:
the braille block according to claim 1;
a blind guidance device including a camera that the visually impaired carry and that recognizes the QR code displayed on a surface of the braille block; and
a center server that provides content linked to various information contained in the QR code.

5. The system of claim 4, wherein the blind guidance device further comprises an information processing unit that analyzes information contained in the QR code recognized through the camera and provides various information to the visually impaired,
wherein the information processing unit comprises a route guidance unit that analyzes information contained in the QR code and provides guidance on a route to a destination to the visually impaired.

6. The system of claim 5, wherein the route guidance unit comprises:
an entry direction analysis module that identifies an entry direction of the visually impaired on the basis of where the QR code recognized by the camera is located in the braille block;
a movement route analysis module that identifies a movement route of the visually impaired on the basis of an order of the QR code recognized by the camera; and
a movement information guidance module that provides guidance on a next movement information to the visually impaired on the basis of the movement route analyzed by the movement route analysis module and the entry direction to a current braille block analyzed by the entry direction analysis module.

7. The system of claim 6, wherein the movement information guidance module precisely calculates a route by correcting a difference between a GPS location value of the QR code information recognized by the camera and a GPS location value received by the blind guidance device when calculating the route that provides guidance on the next movement information to the destination to the visually impaired.

8. The system of claim 6, wherein the center server comprises:
a braille block feedback unit that analyzes and provides information necessary to make corrections related to the braille block on the basis of feedback information of the route guidance unit,
wherein the braille block feedback unit comprises:
a braille block location feedback module that analyzes and provides the information necessary to make corrections to a location of the braille block by analyzing whether the visually impaired actually move to a guided braille block or enter in a correct direction through the entry direction analysis module or the movement route analysis module in comparison with a movement information provided through the movement information guidance module; and
a QR code information feedback module that analyzes and provides the information necessary to make corrections related to QR code information contained in the braille blocks by analyzing the movement route the visually impaired actually move along through the movement route analysis module in comparison with the movement information provided through the movement information guidance module.

9. The system of claim 5, wherein the information processing unit further comprises a customized information provision unit that provides customized information for a corresponding visually impaired person on the basis of information related to the visually impaired, information contained in the QR code, or content provided through the center server.

10. The system of claim 9, wherein the customized information provision unit comprises:
an input information analysis module that analyzes information provided by the visually impaired, such as a taste or an interest;
a user analysis module that analyzes information of interest to the corresponding visually impaired person on the basis of information of the destination frequently visited by the visually impaired through the route guidance unit; and
a customized information provision module that selects and provides customized information suitable for the corresponding visually impaired person among information contained in the QR code or content provided through the center server on the basis of information analyzed and provided through the input information analysis module and the user analysis module.

11. An information guidance system for the visually impaired using a braille block with a QR code displayed for guiding the visually impaired, the system comprising:
the braille block according to claim 2;
a blind guidance device including a camera that the visually impaired carry and that recognizes the QR code displayed on a surface of the braille block; and
a center server that provides content linked to various information contained in the QR code.

12. An information guidance system for the visually impaired using a braille block with a QR code displayed for guiding the visually impaired, the system comprising:
the braille block according to claim 3;
a blind guidance device including a camera that the visually impaired carry and that recognizes the QR code displayed on a surface of the braille block; and
a center server that provides content linked to various information contained in the QR code.
